(19) United States
(12) Patent Application Publication
(10) Pub. No.: US 2024/0235715 A1
(43) Pub. Date: Jul. 11, 2024

(54) OPTICAL NODE AND OPTICAL TRANSCEIVER

(71) Applicant: Telefonaktiebolaget LM Ericsson (publ), Stockholm (SE)

(72) Inventors: Roberto MAGRI, Genova (IT); Stefano ORSI, Genova (IT); Francesco CISAMOLO, Genova (IT)

(21) Appl. No.: 18/567,993

(22) PCT Filed: Jun. 9, 2021
(86) PCT No.: PCT/EP2021/065538

§ 371 Date: Dec. 7, 2023

(51) Int. Cl. H04J 14/02; H04B 10/40

(52) U.S. Cl. CPC H04J 14/0202; H04J 14/0272; H04B 10/40

(57) ABSTRACT

Embodiments described herein relate to methods and apparatus for autotuning an optical system. There is provided a method including transmitting an optical signal on a first transmitter of an optical transmission unit at a predetermined wavelength, and determining whether the predetermined wavelength corresponds with an operational wavelength associated with an input port of an optical multiplexing unit to which the first transmitter is coupled. The determination is dependent on detection of a non-optical fault signal from the optical multiplexing unit.

### TECHNICAL FIELD

The present disclosure relates to an optical node and to an optical transceiver. The present disclosure also relates to methods for operating an optical node and an optical transceiver, a controller for an optical transceiver and a computer program product configured to carry out methods for operating an optical node and an optical transceiver.

### BACKGROUND

Mobile traffic bandwidth demand in communication networks has increased dramatically in recent years, and is predicted to continue increasing, in particular with the implementation of 5G mobile networks. In order to accommodate this increasing demand, the optical fronthaul of Radio Access Networks (RANs) is evolving to implement Dense Wavelength Division Multiplexing (DWDM) solutions. DWDM enables more efficient use of existing fiber infrastructure through multi-channel communications. Wavelength tuneable transceivers, capable of operating at a range of frequencies within an operational band, can both simplify and reduce costs associated with supply, inventory, and operation of DWDM fronthaul networks.

On deployment of wavelength tuneable transceivers, a solution is needed to quickly tune the transceivers, enabling the correct two-way communication. Such tuning should ideally be automatic and require minimal time, so ensuring serviceability.

Automatic wavelength tuning of transceivers is available in the form of bi-directional communication protocols. Such protocols involve a dedicated communication channel that is used to exchange setting information between a master transceiver and a slave transceiver. The dedicated communication channel is either a pilot-tone superimposed on the traffic signal or is part of the frame overhead in a framed protocol. Example automatic wavelength tuning protocols include those set out in the International Telecommunication Union Telecommunication Standard Sector (ITU-T) Recommendation G698.4, the Proprietary Self-Tuning with transceiver-to-transceiver digital optical communication (T2DOC), and proprietary Self-Tuning with sideband communication channel between transceivers.

Each of the above mentioned automatic tuning solutions requires a bi-directional hand-shaking protocol between endpoints. This is typically a relatively slow process, and can take up to 10 minutes to complete. In addition, wavelength tuning cannot be started until the entire End to End (E2E) connection is correctly established. Any fiber mismatch in the E2E connection will cause the tuning protocols discussed above to fail.

Troubleshooting such a failure can be extremely challenging, owing to a lack of feedback concerning the cause of the failure. In addition, with the exception of G698.4 these solutions are proprietary and therefore can't support interworking.

WO2012/043424 offers an alternative approach not based on E2E protocols and uses wavelength sweeping to tune each side independently. This can significantly improve tuning times to around 1 minute, however even faster tuning times are desirable.

### SUMMARY

It is an aim of the present disclosure to provide an optical transmitter unit, an optical multiplexing unit, a module for an optical multiplexing unit, and associated methods and computer readable media which at least partially address one or more of the challenges discussed above.

According to a first aspect of the present disclosure, there is provided a module for an optical multiplexing unit. The module comprises an add port to receive an input optical signal for multiplexing and a common port for transmitting an output optical signal comprising an operational wavelength corresponding to the module. The module is configured to couple the input optical signal received on the add port and matching the operational wavelength of the module to the common port. A fault signal generating circuit is arranged to generate a non-optical fault signal in response to receiving an input optical signal on the add port which does not match the operational wavelength of the module.

This approach provides a number of advantages including allowing the module to provide a non-optical fault signal to an optical transmitter coupled to the module, but which is transmitting on a non-operational wavelength of the module. The optical transmitter may then be re-tuned to another wavelength and another optical signal transmitted for checking using the fault signaling function of the module. In some embodiments the operational wavelength of the module is signaled with the non-optical fault signal which enables faster re-tuning. The use of a non-optical fault signal enables the use of readily available and inexpensive components and does not require any optical modifications which can be challenging and expensive. This approach also does not require end-to-end communication as required by some other approaches; and more generally provides a fast solution for tuning a transmitter unit having multiple ports coupled to respective ports of an optical multiplexing unit each associated with a module having a respective operational wavelength.

In an embodiment the fault signal generating circuit may be a wireless transmission unit or an electronic circuit including control wires. The wireless transmission unit may be a Radio Frequency Identification, RFID, tag. In an embodiment the fault signal generating circuit may comprise a photodetector arranged to detect a predetermined power level of optical radiation in order to generate the non-optical fault signal.

In an embodiment module has an auxiliary port and a filtering element configured to couple an input signal received on the add port and not matching the operational wavelength of the module to the auxiliary port. The fault signal generating circuit may be arranged to generate the fault signal in response to detecting an optical signal on the auxiliary port.

In an embodiment a plurality of modules may be arranged to form an optical multiplexing unit, where each module associated with a respective operational wavelength.

According to a second aspect there is provided an optical transmitter unit for coupling to an optical multiplexing unit. The optical transmitter unit comprises a plurality of output ports each coupled to a respective optical transmitter operable to transmit optical signals at one or more wavelengths and a fault detecting circuit arranged to detect a non-optical fault signal from the optical multiplexing unit. A processor and memory containing instructions executable by said processor to enable the optical transmitter unit transmit an optical signal on a first output port at a predetermined wavelength and use the fault detecting circuit to determine whether the predetermined wavelength corresponds with an operational wavelength associated with an input port of the optical multiplexing unit to which the first output port is coupled.

In an embodiment, the optical transmitting unit is operative to associate the first output port with a different predetermined wavelength in response to detecting the non-optical fault signal. In an embodiment the optical transmitting unit may be operative to transmit an optical signal on the first output port at a different predetermined wavelength indicated by the non-optical fault signal and to associate the first output port with a different predetermined wavelength in response to not detecting the fault signal. The optical transmitting unit may be operative to associate the first output port with the predetermined wavelength of the transmitted optical signal in response to not detecting the non-optical fault signal.

In an embodiment the non-optical fault signal may comprise an indication of an operational wavelength which may be used by the optical transmitting unit to re-tune the optical signal on the first port to the different predetermined wavelength. The non-optical fault signal may be an RFID signal. The optical transmitter unit may comprise a register to associate each output port of the optical transmitter unit with an operational wavelength corresponding to an input port of the multiplexing unit.

In another aspect, there is provided a method of auto-tuning an optical system. The method comprises transmitting an optical signal on a first transmitter of an optical transmission unit at a predetermined wavelength, determining whether the predetermined wavelength corresponds with an operational wavelength associated with an input port of an optical multiplexing unit to which the first transmitter is coupled. The determination is dependent on detection of a non-optical fault signal from the optical multiplexing unit.

In an embodiment the predetermined wavelength may be determined to correspond with the operational wavelength associated with the input port of the optical multiplexing unit in response to not detecting the non-optical fault detection signal. The predetermined wavelength may be determined not to correspond with the operational wavelength associated with the input port of the optical multiplexing unit in response to detecting the non-optical fault detection signal.

In an embodiment the method comprises transmitting another optical signal at a different predetermined wavelength on the first transmitter and determining whether the different predetermined wavelength corresponds with the operational wavelength associated with the input port of the optical multiplexing unit to which the first transmitter is coupled.

In an embodiment the non-optical fault detection signal comprises an indication of the operational wavelength associated with the input port of the optical multiplexing unit, and wherein the different predetermined wavelength is the operational wavelength indicated by the fault detection signal.

In an embodiment the method comprises transmitting an optical signal on a second transmitter of the optical transmission unit at a second predetermined wavelength, and determining whether the second predetermined wavelength corresponds with an operational wavelength associated with a second input port of the optical multiplexing unit to which the second transmitter is coupled.

In an embodiment, the method comprises, in response to determining that a predetermined wavelength of an optical signal transmitted on a said transmitter of the optical transmission unit corresponds with a respective operational wavelength associated with an input port of the optical multiplexing unit to which the said transmitter is coupled, associating the transmitter with said operational wavelength.

In an embodiment the method comprises associating the transmitter with an upstream wavelength corresponding to the associated predetermined wavelength, and forwarding an indication of the upstream wavelength to a remote unit by transmitting the indication on an optical signal using the associated predetermined wavelength on the transmitter.

In an embodiment, the non-optical fault signal is an RFID signal.

According to another aspect of the present disclosure, there is provided a computer program comprising instructions which, when executed on at least one processor, cause the at least one processor to carry out a method according to any one of the preceding aspects or examples of the present disclosure.

According to another aspect of the present disclosure, there is provided a carrier containing a computer program according to the preceding aspects or examples of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect or examples of the present disclosure.

According to another aspect of the present disclosure, there is provided a system for optical transmission, the system comprising an optical multiplexing unit according to any one of the preceding aspects or examples of the present disclosure, and an optical transmitter unit according to any one of the preceding aspects or examples of the present disclosure, wherein the optical transmitter unit is coupled to the optical multiplexing unit via an optical fibers.

According to examples of the present disclosure, the optical transmitter unit may be configured to carry out a method according to any one of the preceding aspects or examples of the present disclosure.

### BRIEF DESCRIPTION OF THE DRAWINGS

For a better understanding of the present disclosure, and to show more clearly how it may be carried into effect, reference will now be made, by way of example, to the following drawings, in which:

FIG. 1 is a block diagram illustrating an optical communications system;

FIG. 2 is a block diagram illustrating a module for an optical multiplexing unit;

FIG. 3 is a block diagram illustrating connections between ports of an optical transmitter unit and an optical multiplexing unit;

FIG. 4 is a circuit block diagram of a fault generating signal circuit;

FIG. 5 is a flow chart illustrating process steps in a method for operating an optical transmitter unit; and

FIG. 6 is a block diagram illustrating a controller for an optical transmission unit.

### DETAILED DESCRIPTION

Examples of the present disclosure propose an auto tuning solution according to which feedback is provided from an optical multiplexing unit to an optical transmitter unit. This feedback is generated using optical signals from the optical transmitter unit and allows for self-contained local wavelength tuning between the two components. As such, there is no requirement for E2E handshaking, i.e. requiring optical communication between two end points of a communication, such as a remote site node and a main site node. In some examples, the auto tuning is carried out within a single site. This local auto tuning is considerably faster than E2E protocols, and also simplifies troubleshooting of fiber misconnection. An auto tuning solution according to examples of the present disclosure can be implemented with minimal component modification according to different examples. In one example, a fault signal detecting circuit is introduced to an optical transmitter unit to monitor for non-optical fault signals from an optical multiplexing unit to which it is at least partially coupled by optical fibers. The non-optical fault signals may be generated at the optical multiplexing unit using optical signals received from the optical transmitting unit, for example using a reflective element used to direct some wavelengths to a photodetector. Optical signals having the “wrong” wavelength are then reflected to the photodetector in order to generate the non-optical fault signal.

In operation, an optical transmitter unit may scan or transmit different wavelengths and receive non-optical fault signals from the connected optical multiplexer unit unless the correct wavelength for ongoing communication with the optical multiplexer unit is transmitted. The lack of such a fault signal indicates correct coupling with the bandpass response of a filter-based multiplexer. That is the wavelength of the optical signal transmitted from a port of the optical transmitter unit coincides with the operational wavelength of the multiplexer port to which the transmitter port is coupled. An optical transmitter unit having multiple transmitters each with a respective port and each tuned to a different wavelength can then be correctly connected to ports of an optical multiplexing unit having matching operational wavelengths.

FIG. 1 is a block diagram illustrating an optical system 100 according to a first aspect of the present disclosure. The optical system 100 comprises a semi-passive network which may be employed in a wireless communications fronthaul network. In this topology, an active main site 110 with enhanced monitoring capabilities is connected to one or more remote sites 190 via a fiber network 160 having a Point-To-Point (PTP) or Point-to-Multipoint (PTMP) topology. For simplicity of explanation, only downstream operation is described, however it will be appreciated that upstream functionality may be added and this is described in other examples.

The remote site 190 comprises a multiplexing unit 192 which drops or receives one or more predetermined wavelengths from the fiber network 160 to a local active unit, e.g. optical transceiver 194. The transceiver 194 is tuned to receive and convert an optical signal on this wavelength into the electrical domain, for example for use with a radio transmitter to provide a communications air interface such as 5G NR.

The active main site 110 comprises an optical transmitting unit 120 and an optical multiplexing unit 140 coupled to the fiber network 160. The optical transmitter unit 120 comprises a plurality of optical transmitters having tunable lasers 124 each connected to a respective output port 122. Each optical transmitter 124 is configured to output an optical signal at a respective downlink wavelength which will correspond with the predetermined downlink wavelength associated with a remote site 190. The optical transmitter unit 120 also comprises a processor 132 and memory 134 together with a fault detection circuit 126.

The optical multiplexing unit 140 comprises a number of modules 144 each associated with an input port 142 and having a fault signal generation circuit 146. Each module is associated with a respective operational wavelength and is configured to add or multiplex an optical signal on the operational wavelength to a Wavelength Division Multiplexing (WDM) signal, e.g. a Dense Wavelength Division Multiplexing (DWDM) signal, to be output onto the fiber network 160. Any optical signals received on a different (non-operational) wavelength are not multiplexed into the WDM signal by the module 144.

Instead, these optical signals on non-operational wavelengths are used to generate a non-optical fault signal using the module's fault signal generation circuit 146.

As will be described in more detail below, the fault signal generation circuit 146 of each module 144 generates a non-optical fault signal when an optical signal is received by the module which does not match the bandpass response of the module's multiplexing functionality. In an example, the module is arranged to reflect wavelengths which do not match the bandpass response to a photodetector. In this way, an optical signal at one of these non-operational wavelengths is received at the photodetector which changes the electrical characteristics of the photodetector. The change in electrical characteristics may be employed in a circuit to generate an electrical signal. This electrical signal initiates the non-optical fault signal, or may be considered as the non-optical fault signal, or may be used to generate the non-optical fault signal. Therefore, if an optical transmitter 124 associated with a particular wavelength is coupled using an optical link fiber 150 to an input port 142 of the optical multiplexing unit which is associated with a different wavelength, a non-optical fault signal will be generated. This may be used to ensure that the ports 122 of the optical transmitter unit 120 are correctly coupled to ports 142 of the optical multiplexing unit 140, or that the transmitters 124 of the optical transmitter unit are correctly tuned to the modules to which they are connected.

This process of tuning transmitters 124 of the optical transmitter unit to the operational wavelengths of the modules of the optical multiplexing unit to which they are coupled is known as autotuning. The autotuning process correctly tunes each transmitter unit or indicates faults in the coupling of the optical transmitter unit and the optical multiplexing unit. The dashed line 170 indicates a pathway through the components of the optical system 100 in which a transmitter 124 transmitting optical signals on downlink wavelength λdx has been correctly coupled, via optical fiber link 150, to a module 144 of the optical multiplexing unit 140 having a bandpass response including wavelength λdx. These optical signals are then multiplexed together with many other optical signals at different wavelengths onto a DWDM signal transmitted onto the fiber network 160. An add/drop multiplexer 192 at a remote site is configured to recover optical signals at wavelength λdx and a transceiver 194 is arranged to convert these to electrical signals for further processing.

The fault detecting circuit 126 of the optical transmitter unit 120 is arranged to receive non-optical fault signals generated by the fault signal generating circuits 146 on the optical multiplexing unit 140. In one example the non-optical fault generation signals may be electrical signals. This may be implemented using control wires from each fault signal generating circuit 146 to the fault detecting circuit 126, or a control signal wire with multiplexed signals from the fault generating circuits 146. In some implementations the non-optical fault signals may include information about their respective module and/or its operational wavelength. For example, a module which receives an optical signal at a non-operational wavelength may include a code referring to the operational wavelength in the non-optical fault signal. This can be implemented using appropriate processors and memory.

In an implementation, the wireless signals may be Radio Frequency IDentification (RFID) signals. The fault signal generating circuits 146 may be active RFID tags with their own power supply such as a local battery, or they may be passive tags which are “illuminated” or powered using a signal from an RFID reader device at the fault detecting circuit 126. As with electrical fault signals, the wireless fault signals may include information about with the modules with which they are associated; for example the module's operational wavelength or a code to identify this.

The memory 134 comprises a register 136 to associate the downlink wavelength to be used by each optical transmitter 124 with a respective operational wavelength of the optical multiplexing unit so that the optical transmitter unit 120 knows which transmitter 124 to direct downlink signals to for a particular remote site associated with that downlink wavelength. For a particular optical system 100 it is known a priori that a particular remote site 190 is configured to receive downlink communications on a particular wavelength λdx but it is initially not known which port 122 or transmitter 124 this is coupled with as this depends on the particular way in which an installer couples the optical link fibers 150 between the output ports 122 of the optical transmitter unit 120 and the input ports 142 of the optical multiplexing unit 140. The auto-tuning process, as explained in more detail below, allows this information to be determined and added to the register 136 so that communications can be correctly addressed or directed over the system 100.

In another example the non-optical fault signals may be wireless or radio signals, for example using Bluetooth™, WiFi™ or other radio signal transceivers.

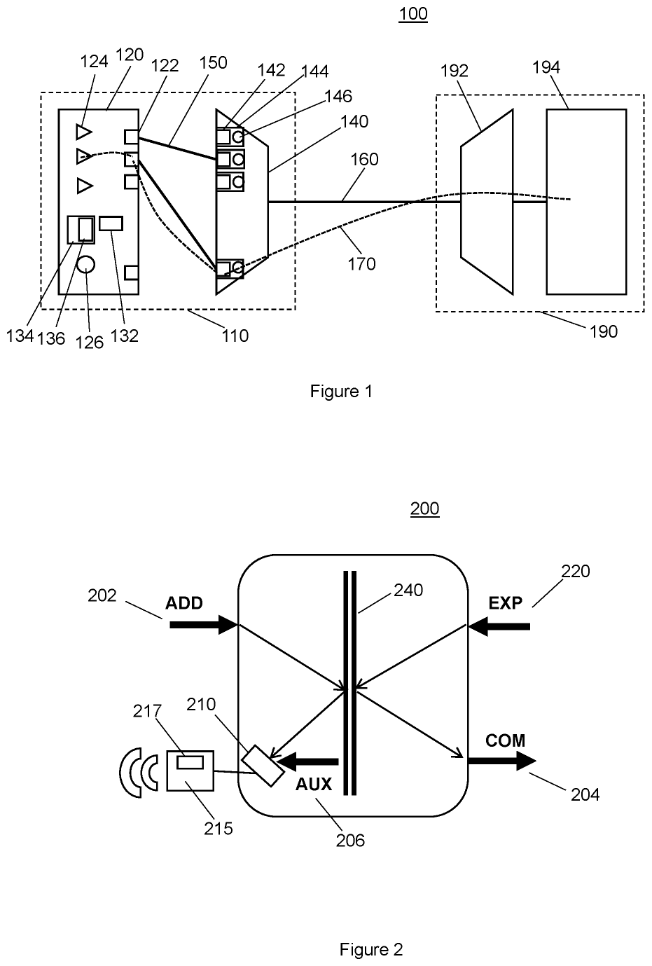

FIG. 2 illustrates a module of the optical multiplexing unit according to one embodiment. The module 200 is an optical component, for example an integrated device or a combination of separate optical parts such as filters and waveguides. The module comprises an add port 202, a common port 204, an auxiliary port 206, and an express port 220. The module 200 is configured to couple an optical signal received on the add port 202 and matching an operational wavelength of the module 200 to the common port 204, and to couple an optical signal received on the add port 202 and not matching an operational wavelength of the module to the auxiliary port 106. The operational wavelength may also be referred to as the correct wavelength or intended wavelength. It will be appreciated that in practice the operational wavelength may be a band or range of wavelengths corresponding to the bandpass response of the module. The non-operational wavelength may also be referred to as the wrong wavelength.

The optical transfer configuration of the module 200 may be implemented using an optical filtering element 240 such as a Thin Film Filter (TFF), or may comprise the planar regions and coupling waveguides of an Arrayed Waveguide Grating (AWG). In an example, a reflecting element reflects the non-operational wavelengths to the aux port 206. The reflecting element may be integral with the optical filtering element 240 or it may be a separate component. For example, a TFF structure may be arranged to couple operational wavelength(s) from the add port 202 to the common port 204 and to reflect all other wavelengths to the aux port 206. However separate elements may alternatively be used.

The express port 220 is coupled to the common port 204 such that express channels are reflected to the common port 204 via the filtering element 240. Thus, the device (e.g. optical module 144, 200) is configured to output, at the common port, the wavelengths received on the express port and the one or more operational wavelengths received on the add port. The common port provides for wavelengths to be added to the express (or pass-through) wavelengths received at the device, e.g. as part of an add-drop multiplexer. In this way, the module multiplexes the optical wavelengths on the express port with the operational wavelengths on the add port. Signals received on the add port 202 and not matching the pass band of the filter layer 240 are reflected back to the “internal” fourth port, which serves as the auxiliary port 206 in the present example.

When the optical wavelength coupled with the add port 202 is the correct wavelength for the filter layer 240, no significant reflection is present at the add port 342 (apart from the Optical return Loss (ORL) of the common port 220). When the wavelength coupled to the add port 202 is not the correct wavelength, the light is reflected by the filter layer 240 to the auxiliary port 206 and is received by a photodetector 210 such as a photodiode.

More details of a suitable four port module are provided in WO2021/043424, the contents of which are hereby incorporated. However, the reflecting element described therein coupled to the auxiliary port may be replaced with a fault signal generating circuit 146 as described herein.

The photodetector 210 optically coupled to the auxiliary port 206 forms part of a fault signal generating circuit 146 which is arranged to generate a non-optical fault signal when the light energy incident on the photodetector exceeds a predetermined threshold, for example an optical power level. This may occur when an optical signal having a non-operational wavelength is received at the add port 202 and reflected by the TTL 240 to the auxiliary port 206.

The photodetector 210 may be arranged to generate an electrical signal or to change its electrical characteristics in an electrical circuit. For example, a photodiode in a battery powered circuit may change its conductance or another electrical property in a circuit which can be detected by a fault detecting circuit 126 in the optical transmission unit 120. This may be achieved using a control wire(s) connected to the fault detecting circuit, or as illustrated in FIG. 2, using a wireless transmission unit 215. The wireless transmission unit 215 is coupled to the photodetector 210 and arranged to transmit a wireless fault signal in response to the photodetector indicating the presence of a non-operational wavelength. The wireless transmission unit 215 may comprise information about the operational wavelength of the module, for example a code contained in a memory 217. This information may be transmitted as the wireless fault signal or as part of the wireless fault signal to provide an indication of the operational wavelength of the module 200, 144. In an example, the wireless transmission unit 215 may be a Radio Frequency Identification (RFID) tag. This may be an active RFID tag powered by a local battery or a power source provided to the optical multiplexing unit. Alternatively, a passive RFID tag may be used which is activated by a transmission from an RFID reader on the optical transmitting unit together with the photodetector 210 receiving optical power above a threshold.

It will be appreciated that in order to incorporate the module 200 into the optical multiplexing unit 140, the add port 202 of each module is coupled to a respective input port of the optical multiplexing unit 140. The common port 204 and the express port 220 of the module 200, 140 may be connected to the common and express ports of other modules 144 as described below. It will also be appreciated that the pass-band of the filter layer 240 of each module 144 effectively defines the operational wavelength of that module.

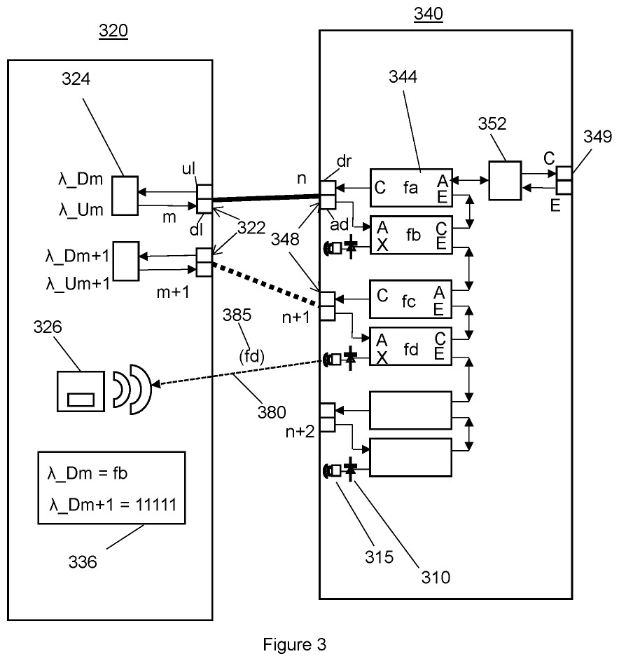

FIG. 3 illustrates an optical transmitting unit 320 and an optical multiplexing unit 340 according to an embodiment. Each comprises a plurality of ports and in this example both downlink and uplink components are shown. The optical transmitting unit 320 may therefore be considered an optical transceiver unit having a plurality of transceivers 324 to transmit a downlink optical signal on respective downlink wavelengths λ_Dm, λ_Dm+1 and to receive uplink optical signals on respective uplink wavelengths λ_Um, λ_Um+1.

The transceivers may comprise tunable lasers in order to enable the transmission of optical signals at different wavelengths. The transceiver 320 has input (uplink) and output (downlink) ports 322m, 322m+1 for each transceiver 324. Only two sets of transceivers 324 and ports 322 are illustrated, but it will be understood that in practice there may be more. The unlink and downlink ports of the first transceiver (m) are labelled ul (uplink) and dl (downlink), although it will be understood that whilst the other ports could be similarly labeled, these labels have been omitted for clarity. Alternatively separate transceivers may be used for uplink and downlink optical signals.

The optical transceiver unit 320 also comprises a fault detecting circuit 326 and a register 336. The fault detecting circuit 326 is arranged to receive non-optical fault signals from the optical multiplexing unit 340 and may be implemented as an RFID Reader for example. The register 336 is used to record the operational wavelength fb, fd of the module 344 of the optical multiplexing unit 340 to which each downlink transceiver 324 is connected. The register may also be used to record which uplink wavelength each transceiver is associated with.

The multi-port optical multiplexing unit 340 or Add/Drop Mux/Demux comprises a plurality of modules 344 chained together, each coupled to respective add and drop ports 348n, 348n+1, 348n+2. Only three sets of modules 344 and corresponding add/drop ports 348 are illustrated, but it will be understood that in practice there may be many more. The add and drop ports corresponding to the first module (n) are labelled ad (Add) and dr (drop), although it will be understood that whilst the other ports could be similarly labelled, these labels have been omitted for clarity. The modules may be the modules 200 as previously described, although in the case of uplink channels only three of the module ports are required—a common port C which is coupled to a respective output or drop port 348 of the optical multiplexing unit 340; an add port A which receives optical uplink signals from a DWDM signal port 349 via a skip filter 352; an express port E which passes these signals to other modules. These upstream modules are configured for dropping or demultiplexing uplink signals from a DWDM signal from the DWDM port 349, in particular to extract uplink signals corresponding to their respective operational wavelength fa, fc. These dropped optical signals are output at the common port C to be provided at a corresponding drop or output port 348n, 348n+1 of the optical multiplexing unit 340. These are then coupled to a transceiver 324 on the optical transceiver unit 320 using an optical link fiber. When configured as an uplink module, the auxiliary port X is not connected.

Modules 344 configured as downlink modules may be arranged as described with respect to FIG. 2 and where the aux port X is connected to a fault signal generating circuit 310 and a non-optical or wireless transmission circuit 315. The add port A of the module is connected to an input or add port 348n, 348n+1 of the optical multiplexing unit 340 and receives optical signals from a transceiver 324 when coupled to an output port 322 of the optical transceiver unit 320. The express port is coupled to receive optical signals from other modules 344 and the common port C is coupled to forward optical signals to other modules and the DWDM port 349 via skip filter 352. These downstream modules are configured for adding or multiplexing downlink signals received respective input ports 348n, 348n+1 of the optical transceiver unit 320 if these match their respective operational wavelengths fb, fd. In this case these received optical signals are multiplexed with other optical signals into a DWDM signal and forwarded to the DWDM port 349 via the skip filter 352.

The skip filter 352 facilitates band splitting in DWDM applications, although other filter types may alternatively be used to help narrow transitions from pass band to blocking band. In some embodiments, the skip filter may be omitted.

When the transceivers 324 are properly tuned to the operational wavelength of the module 344 to which they are coupled, then optical signals on these wavelengths are transmitted by the transceivers 324, multiplexed by the downlink configured modules 344 of the optical multiplexing unit 340 into a DWDM downlink signal output from the DWDM port 349 to remote sites. The remote sites will be configured to transmit uplink signals on predetermined wavelengths which are received by the optical multiplexing unit 340 and demultiplexed by the uplink configured modules 344 to be received by respective transceivers 324.

As described in more detail below, the fault signal generating circuits 310, 146 of the optical multiplexing unit 340 and the fault detecting circuit 326 of the optical transceiver unit 320 may be used to automatically tune the transceivers 324 to the operational wavelengths of the modules in the optical multiplexing unit 340 to which they are coupled.

If the optical signals received by a downlink configured module 344 do not match its operational wavelength fb, fd, these signals are coupled to the aux port X in order to generate a non-optical fault signal 380. The non-optical fault signal 380 may include an indication 385 of the operational wavelength (fd) of the module sending the fault signal 380.

Once the ports 322 of the optical transceiver unit 320 are coupled to ports on the optical multiplexing unit 340, an auto-tuning procedure may be employed in order to tune the transceivers 324 of the optical transceiver unit 320 to the operational wavelength of the module 344 of the optical multiplexing unit 340 to which they are coupled.

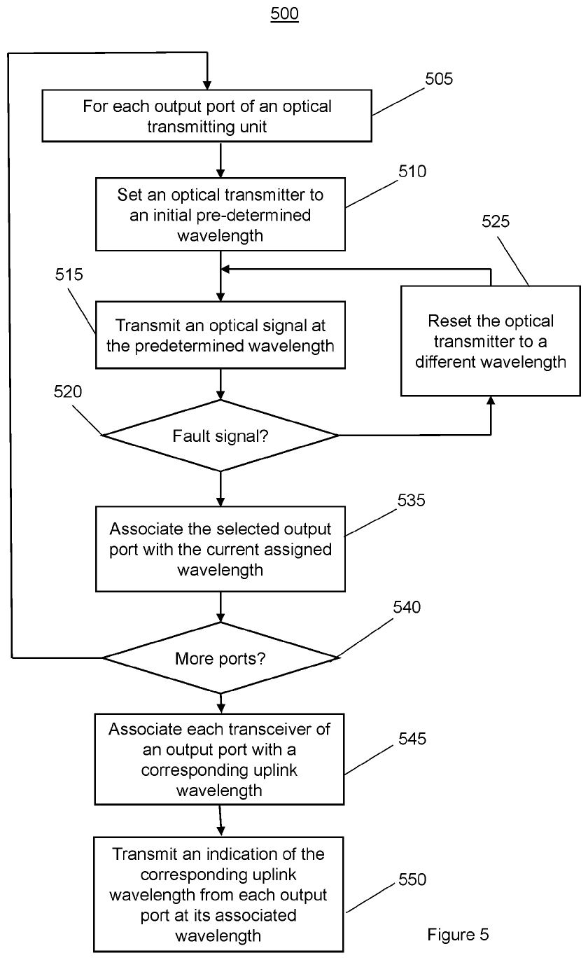

An auto-tuning method according to an embodiment is illustrated in FIG. 5 and may be implemented using a processor 132 in the optical multiplexing unit 120, 320. Referring also to FIG. 3, the auto-tuning method 500 determines the operational wavelength fb, fd of the module 344 to which each transceiver 324 and output port 322 is coupled. At step 505, each transceiver 324 or output port 322 may be processed one at a time in any suitable order, for example sequentially by output port number.

Once an output port 322m and transceiver or transmitter 324m has been selected, at step 510 an initial preassigned wavelength is set for optical signals transmitted from the selected transceiver 342m. At step 515, the transceiver is tuned to the assigned wavelength and transmits an optical signal to the coupled module 344n. The module 344n in the optical multiplexing unit 340 receiving this optical signal will either pass this through to its common port C or reflect this to its auxiliary port X, depending on whether the wavelength of the optical signal matches the operational wavelength fb of the module. If the received optical signal is coupled to the auxiliary port X, this will cause generation of a non-optical fault signal, such as an RFID wireless signal as previously described. The non-optical fault signal may include an indication of the operation wavelength fb of the module 344n. If the received optical signal is coupled to the common port C, no non-optical fault signal will be generated by the module.

At step 520, the method determines whether a non-optical fault signal is being detected. In an example implementation, this may be determined by monitoring a fault signal detection circuit 326 such as an RFID reader. If a non-optical fault signal is detected, the method moves to step 525 where a different wavelength is assigned to the selected output port 322m. This different wavelength may be predetermined for example using the next in a series of wavelength assignments to be tried sequentially. Alternatively, where the non-optical fault signal includes an indication of the operational wavelength fb of the connected module 322n, the different wavelength is assigned as this indicated wavelength fb. This approach reduces the need to scan through all available downlink wavelengths which reduces the overall autotuning time. The method then returns to step 515 where an optical signal at the newly assigned wavelength fb is transmitted to the connected module 344n. The method then again determines whether a non-optical fault signal has been detected at 520. If a non-optical fault signal is again detected, a new different wavelength is set at step 525 and the process repeated again. This may occur if there was some fault in receiving the indication of the operation wavelength.

If a non-optical fault signal is not detected, the method moves to step 535 where the wavelength assigned to the selected transceiver 324m and output port 322m is associated with these components. This may be achieved for example by pairing a downlink wavelength variable λ_Dm for the selected transceiver 324m with the determined operational wavelength fb of the connected module 344. Each transceiver or output port 322 association in the register may initially be set to a “not tuned” encoding and the association for the selected transceiver or port 322m is updated to the currently assigned wavelength when a non-optical fault signal is not received.

Once the operational wavelength of the connected module is associated with the selected transceiver or output port, the method moves to step 540 to determine whether there are any existing transceivers or output ports 322 which have not yet been associated with an operational wavelength. This may be achieved by checking the register for any “not tuned” encoding. If there are still outstanding transceivers or output ports to tune, the method returns to step 505 where a new transceiver 324m+1 or output port 322m+1 is selected. The method then repeats steps 510, 515, 520, 525 as needed until the operational wavelength fd of the module 344n+1 connected to the selected transceiver 324m+1 and output port 322m+1 is determined. The determined operational wavelength fb is then associated at step 535 with the downlink wavelength variable λ_Dm+1 of the selected output port 322m+1 and transceiver 324m+1. This process continues until all transceivers 324 and output ports 322 have a downlink wavelength associated with the operational wavelength of the module to which they are coupled.

At step 540, once the transceivers 324 of all of the output ports 322 have been tuned, the method moves to step 545. This may be determined by checking the register for any “not tuned” encoding. At step 545, the method associates each transceiver 324 of an output port 322 with a corresponding uplink wavelength. It will be known in advance that each remote site will be associated with a predetermined downlink wavelength and a corresponding predetermined uplink wavelength. Once the downlink wavelength of a transceiver has been determined using the autotuning procedure, the corresponding uplink wavelength can be determined, for example from a list in memory 134 in the optical transceiver unit 320. In the case of a single fiber working (SFW) system the downlink and uplink wavelengths for each transceiver 322 and remote site will be different. For a dual fiber working (DFW) system the downlink and uplink wavelengths may be the same.

At step 550, each transceiver 324 transmits an indication of the corresponding uplink wavelength to its remote site. This may be achieved by transmitting an optical signal comprising the indication on its associated downlink wavelength. This optical signal will be multiplexed into a DWDM signal by the connected module 344 in the optical multiplexing unit 340. The intended remote site will receive or drop this optical signal from the DWDM signal as it is already configured to receive the downlink wavelength used. The remote side then uses the indication to tune its own transceiver laser to transmit optical signals on the indicated uplink wavelength. Optical signals transmitted on the indicated uplink wavelength are then multiplexed into a DWDM uplink signal which is received by the optical multiplexing unit 340. An uplink configured module 344 then drops this optical signal to the input port 322 of the transceiver 322 which transmitted the optical signal downlink wavelength (or an associated transceiver). Handshaking between the optical transceiver unit 320 and each of the remote sites may then be achieved using the correct downlink and uplink wavelengths.

The indication of the uplink wavelength may be added to the common header of an eCPRI (enhanced Common Public Radio Interface) message sent from the transceivers of the optical transceiver unit 320 to each of the remote sites. The structure of an eCPRI message is shown below:

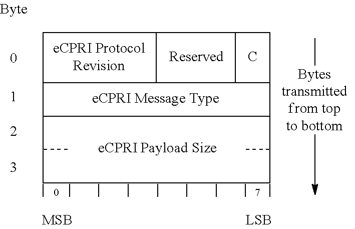

The eCPRI message types from 8 to 63 are reserved and available for use:

| Message Type # | Name |
|---|---|
| 0 | IQ Data |
| 1 | Bit Sequence |
| 2 | Real-Time Control Data |
| 3 | Generic Data Transfer |
| 4 | Remote Memory Access |
| 5 | One-way Delay Measurement |
| 6 | Remote Reset |
| 7 | Event Indication |
| 8-63 | Reserved |
| 64-255 | Vendor Specific |

A typical WDM system may use 48 wavelengths, which may be coded using 6 bits of the reserved message type, although any encoding may be applied.

The auto-tuning method 500 may advantageously tune the transceivers 322 of the optical transceiver unit 320 rapidly to the correct downlink wavelengths corresponding to the ports and hence modules of the optical multiplexing unit 340 to which they are connected. This may be achieved in the order of a few seconds which is significantly faster than known approaches. This in turn allows for the remote sites to be configured quickly with their respective uplink wavelengths and for handshaking between a central hub and remote sites to be completed faster.

The method 500 tunes each transceiver one at a time in order to ensure that only one non-optical fault signal can be transmitted at any one time, in order to avoid collisions.

However in other embodiments, for example using respective control wires, transceivers may be tuned together enabling even faster auto-tuning.

Even when using a wireless fault signal and a single wireless fault signal detection circuit at the optical transceiver unit, reduced tuning time may also be achieved with further modifications. For example, step 525 may be omitted when an indication of the operational wavelength is provided in the non-optical fault signal. When the selected or current transceiver is retuned to this operational wavelength, it may be assumed that this is correct and the check implied by transmitting this again and monitoring for no non-optical fault signal is not performed. The method instead moves straight to the next transceiver.

The time required to process a single transceiver may be given by the RFID feedback which is in the order of the ms and not necessarily by the laser tuning time. Once the operational wavelength has been received from via RFID circuits and stored in the register, the method may move to the next transceiver without waiting to confirm that this is correct by retuning, transmitting and checking for a lack of a non-optical fault signal. This is particularly useful if the tuning time is slow (e.g. several seconds). In this case a modification may be used to avoid the RFID tag sending its wireless fault signal during the tuning time leading to RF collision between the previous and current transceiver. Since the RFID is activated by the laser light it is enough to switch off the laser once the wavelength has been received and stored. All the transceiver lasers to be tuned may be switched on once all their operational wavelengths have been received and stored. In this way the tuning will occur with a further significant time saving with respect to prior art as there is less re-tuning.

At the end of the autotuning process all transceivers are tuned. If something goes wrong due to connection problems, such as an open or faulty connector, the optical transceiver unit detects a loss of signal. In this case the tuning process can be retried for a fixed number of times and/or a warning raised to the operator. Special events like module extraction/replacement will force a register reset in order to restart the tuning once re-plugged.

At the remote site, an optical demux 192 and optical transceiver 194 are configured to receive and process optical signals on a predetermined downlink wavelength. The optical transceiver 194 has a tunable laser that can be set to an uplink wavelength when determined, but is initially off. The remote site then monitors for optical signals. Once an optical signal on the configured downlink wavelength (or a predetermined common wavelength for all remote sites) is received, the remote site checks for an indication of the uplink wavelength to which its laser should be tuned. This may be received in an eCPRI message overhead as described above. Once the remote site's optical transceiver is tuned to this uplink wavelength, optical signals between the remote site and central hub may be exchanged on the downlink and uplink wavelengths in order to enable handshaking and communication between them.

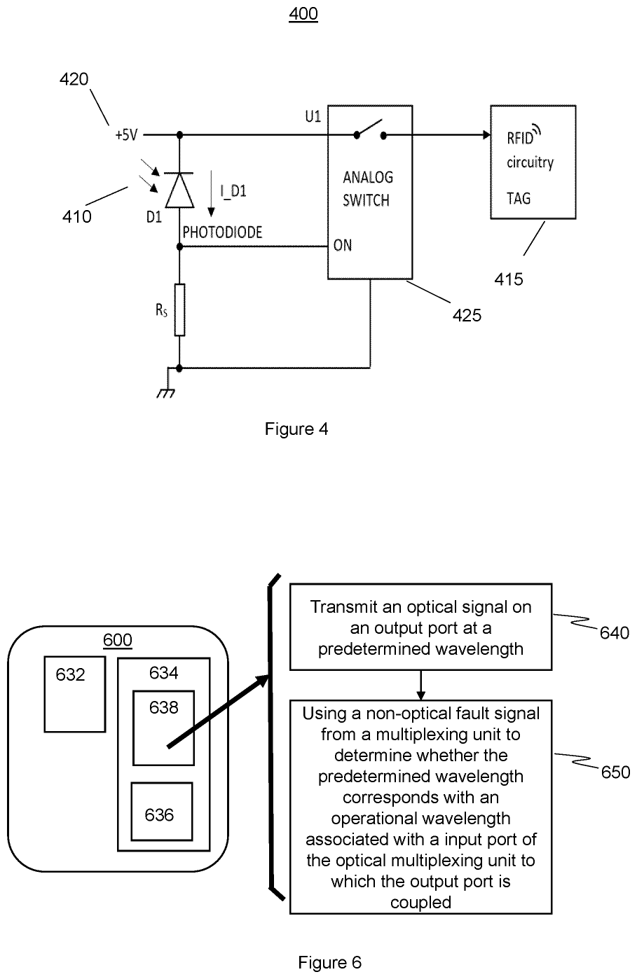

FIG. 4 illustrates a fault signal generating circuit 400 according to an embodiment and which may be employed at each module 144, 344 of an optical multiplexing unit 140, 340. The fault generating circuit 400 is used to generate a non-optical fault signal in response to an optical signal received by the module not being at the operational wavelength of the module 144, 200, 344.

In this embodiment the circuit comprises a photodiode 410 optically coupled to the auxiliary port of a module. The circuit 400 also comprises an analog switch electrically connected to a power supply 420. The power supply may be provided by a local battery connected to all fault signal generating circuits in an optical multiplexing unit. In alternative arrangements the power supply may be an external source such as a mains supply to a central hub housing the optical multiplexing unit. The analog switch 425 has a control input dependent on the conductivity of the photodiode 410 and an output coupled to an RFID tag 415. When powered, the RFID tag transmits an RFID signal when may be received by a proximate RFID reader. The RFID tag 415 may be configured to transmit a code which corresponds to an operational wavelength of the module to which it is associated.

In an example implementation, the photodiode converts optical radiation to a proportional electrical current. The level of optical power indicating the presence of an optical signal transmitted from a transceiver 324 of an optical transceiver unit 320 is approximately −dBm or 320μW. The presence of such a power level corresponds to the presence of an optical signal at a non-operational wavelength and coupled to the auxiliary port of the module. A photodiode with a responsivity close to 1 will then conduct approximately 320 μA of current. This allows the voltage at the control input of the analog switch to rise above an activation threshold, causing the switch to close and conduct power to the RFID tag 415. This in turn causes the RFID tag to transmit a wireless RFID fault signal. This implementation enables long battery life where this is the power source 420, as the power consumed by the RFID tag itself is very low and is only used during the auto-tuning process when a non-operational wavelength is received by a module.

FIG. 6 illustrates a controller 600 that may be adapted to implement the autotuning method 500 of FIG. 5, or another autotuning method using detection of a non-optical fault signal to determine whether a transceiver is correctly tuned to the multiplexing module to which it is coupled. The controller 600 comprises a processor 632 and memory 634 containing executable instructions 638 and a register 636. The register may comprise a mapping between individual transceivers 124, 324 of an optical transmission or transceiver unit 120, 320 and downlink wavelengths to be used by these transceivers. This enables the optical transceiver unit to be properly configured once its ports are connected to respective ports of an optical multiplexing unit 140, 340 in order to allow optical communication with remote sites using those downlink wavelengths. When uplink communications are also used, optical signals on these downlink wavelengths may be used to inform the remote sites which uplink wavelength to tune their lasers to.

The executable instructions 638 may be in the form of a computer program and may include instructions for executing one or more telecommunications and/or data communications protocols. In some examples, the processor or processing circuitry 632 may include one or more microprocessors or microcontrollers, as well as other digital hardware, which may include digital signal processors (DSPs), special-purpose digital logic, etc. The processor or processing circuitry may be implemented by any type of integrated circuit, such as an Application Specific Integrated Circuit (ASIC), Field Programmable Gate Array (FPGA) etc. The memory 634 may include one or several types of memory suitable for the processor, such as read-only memory (ROM), random-access memory, cache memory, flash memory devices, optical storage devices, solid state disk, hard disk drive etc.

The executable instructions 638 may be used to cause the processor 632 to operate an optical transceiver unit according to the method 500 or a similar or corresponding autotuning method having at least the following steps. At 640, a transceiver is controlled to transmit an optical signal at a predetermined wavelength on output or downlink port. This may be an initially assigned wavelength or a wavelength indicated by a non-optical fault signal previously received in relation to the same output port or transceiver.

At 650, a non-optical fault signal from a multiplexing unit is used to determine whether the predetermined wavelength corresponds to an operational wavelength associated with an input port (or a module) of an optical multiplexing unit to which the output port of the optical transceiver unit is coupled. This may be implemented by monitoring for the presence or absence of a non-optical fault signal such as an RFID signal, an electrical control signal or any other suitable wired or wireless fault signal.

The absence of such a non-optical fault signal indicates that the transmitted optical signal is at the operational wavelength of the connected module or multiplexer port and therefore that the laser of the transceiver is correctly tuned for its current connection configuration. The presence of such a non-optical fault signal indicates that the transmitted optical signal is not at the operational wavelength of the connected module or multiplexer port and therefore that the laser of the transceiver is not correctly tuned for its current connection configuration. The laser of the transceiver may then be re-tuned to a different wavelength in order to determine whether this corresponds with the operational wavelength of the connected module or multiplexer port to which it is connected.

This procedure may continue until the correct downlink wavelength is determined; or the correct downlink or operational wavelength may be indicated by the module in response to receiving an optical signal at a non-operational wavelength. Similarly this procedure may be repeated for each transceiver or downlink/output port of the optical transceiver unit until the unit is fully or correctly tuned. Uplink wavelength assignments may then be signaled to respective remote sites coupled to the optical multiplexing unit so that optical communications can be fully configured and implemented.

This assures fast line up if the fibers are correctly connected, and assists with troubleshooting if the fibers are not correctly connected. For example the initial wavelength assignment for each output port of the optical transceiver unit may be indicated visually near the port so that an installer connects this to a similarly labels port on the optical multiplexing unit. If the ports are correctly connected, no non-optical fault signal will be generated when testing each port using the above described method, therefore the autotuning process if completed quickly. When some ports have been incorrectly connected, the corresponding transceivers may be retuned to the indicated operational wavelengths using the non-optical fault signals that will be generated whist processing these ports during the autotuning process.

Embodiments may provide a number of other advantages including faster autotuning and without the need for end-to-end connectivity already in place. Further in some embodiments there is no need for sweeping of wavelengths when tuning each transceiver, which can dramatically reduce tuning time down to a few seconds. No photonics integration modifications are required since the feedback can be provided electrically and/or wirelessly for example using RFID tags and a reader. No proprietary in-band or out-of-band communications is required. Also misconnections can be easily and automatically handled by retuning the affected transceivers.

It will be appreciated that modification of optical transceivers units and optical multiplexing units as described in the present disclosure is both simple and low-cost. Such modification does not require any change in the fabrication process.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A module for an optical multiplexing unit, the module comprising:
an add port to receive an input optical signal for multiplexing;
a common port for transmitting an output optical signal comprising an operational wavelength corresponding to the module;
the module configured to couple the input optical signal received on the add port, and matching the operational wavelength of the module, to the common port;
a fault signal generating circuit arranged to generate a non-optical fault signal in response to receiving an input optical signal on the add port which does not match the operational wavelength of the module.

2. The module of claim 1, wherein the fault signal generating circuit comprise a wireless transmission unit arranged to transmit the non-optical fault signal wirelessly.

3. The module of claim 2, wherein the non-optical fault signal comprises an indication of the operational wavelength of the module.

4. The module of claim 2, wherein the wireless transmission unit comprises a Radio Frequency Identification, RFID, tag.

5. The module of claim 1, wherein the fault signal generating circuit comprises a photodetector to initiate the non-optical fault signal.

6. The module of claim 1, comprising:
an auxiliary port;
a filtering element configured to couple an input signal received on the add port and not matching the operational wavelength of the module to the auxiliary port;
wherein the fault signal generating circuit is arranged to generate the fault signal in response to detecting an optical signal on the auxiliary port.

7. An optical multiplexing unit comprising a plurality of modules according to claim 1, each module associated with a respective operational wavelength.

8. An optical transmitter unit for coupling to an optical multiplexing unit, the optical transmitter unit comprising:
a plurality of output ports each coupled to a respective optical transmitter operable to transmit optical signals at one or more wavelengths;
a fault detecting circuit arranged to detect a non-optical fault signal from the optical multiplexing unit;
a processor and memory, said memory containing instructions executable by said processor whereby said optical transmitter unit is operative to:
transmit an optical signal on a first output port at a predetermined wavelength;
use the fault detecting circuit to determine whether the predetermined wavelength corresponds with an operational wavelength associated with an input port of the optical multiplexing unit to which the first output port is coupled.

9. The optical transmitter unit of claim 8, wherein the processor is operative to associate the first output port with a different predetermined wavelength in response to detecting the non-optical fault signal.

10. The optical transmitter unit of claim 8, wherein the processor is operative to associate the first output port with the predetermined wavelength of the transmitted optical signal in response to not detecting the non-optical fault signal.

11. The optical transmitter unit of claim 9, operative to transmit an optical signal on the first output port at a different predetermined wavelength indicated by the non-optical fault signal and to associate the first output port with a different predetermined wavelength in response to not detecting the fault signal.

12. (canceled)

13. The optical transmitter unit of claim 8, wherein the non-optical fault signal is an RFID signal.

14. A method of auto-tuning an optical system, the method comprising:
transmitting an optical signal on a first optical transmitter of an optical transmission unit at a predetermined wavelength;
determining whether the predetermined wavelength corresponds with an operational wavelength associated with an input port of an optical multiplexing unit to which the first optical transmitter is coupled;
wherein the determination is dependent on detection of a non-optical fault signal from the optical multiplexing unit.

15. (canceled)

16. The method of claim 14, wherein the predetermined wavelength is determined not to correspond with the operational wavelength associated with the input port of the optical multiplexing unit in response to detecting the non-optical fault detection signal.

17. The method of claim 16, comprising:
transmitting another optical signal at a different predetermined wavelength on the first optical transmitter and determining whether the different predetermined wavelength corresponds with the operational wavelength associated with the input port of the optical multiplexing unit to which the first optical transmitter is coupled.

18. The method of claim 17, wherein the non-optical fault detection signal comprises an indication of the operational wavelength associated with the input port of the optical multiplexing unit, and wherein the different predetermined wavelength is the operational wavelength indicated by the fault detection signal.

19. The method of claim 14, comprising:
transmitting an optical signal on a second optical transmitter of the optical transmission unit at a second predetermined wavelength;
determining whether the second predetermined wavelength corresponds with an operational wavelength associated with a second input port of the optical multiplexing unit to which the second optical transmitter is coupled.

20. The method of claim 14, comprising:
in response to determining that a predetermined wavelength of an optical signal transmitted on a said optical transmitter of the optical transmission unit corresponds with a respective operational wavelength associated with an input port of the optical multiplexing unit to which the said optical transmitter is coupled, associating the optical transmitter with said operational wavelength.

21. The method of claim 20, comprising:
associating the optical transmitter with an upstream wavelength corresponding to the associated predetermined wavelength;
forwarding an indication of the upstream wavelength to a remote unit by transmitting the indication on an optical signal using the associated predetermined wavelength on the optical transmitter.

22. The method of claim 14, wherein the non-optical fault signal is an RFID signal.

23-24. (canceled)
